(19) United States
(12) Patent Application Publication
(10) Pub. No.: US 2011/0038308 A1
(43) Pub. Date: Feb. 17, 2011

(54) FORMING SPATIAL BEAMS WITHIN A CELL SEGMENT

(76) Inventors: Yi Song, Plano, TX (US); Geng Wu, Plano, TX (US); Jun Li, Richardson, TX (US); Neng Wang, Plano, TX (US); Kathiravetpillai Sivanesan, Richardson, TX (US); Sang-Youb Kim, Plano, TX (US); Rose Hu, Allen, TX (US); David Paranchych, Kirk land, WA (US); Lai-King Tee, San Diego, CA (US)

Correspondence Address: TROP, PRUNER & HU, P.C., 1616 S. VOSS ROAD, SUITE 750, HOUSTON, TX, 77057-2631, US

(21) Appl. No.: 12/681,118

(22) PCT Filed: Oct. 6, 2008
(86) PCT No.: PCT/US08/78913

§ 371 Date: Nov. 4, 2010

Related U.S. Application Data
(60) Provisional application No. 60/977,425, filed on Oct. 4, 2007.
(60) Provisional application No. 60/977,514, filed on Oct. 4, 2007.
(60) Provisional application No. 60/986,085, filed on Nov. 7, 2007.

(51) Int. Cl. H04W 40/00

(52) U.S. Cl. 370/328

(57) ABSTRACT

To perform wireless communications in a wireless network, at least two spatial beams are formed within a cell segment, where the at least two spatial beams are associated with different power levels. The at least two spatial beams are swept across the cell segment according to a sweep pattern. In some implementations, multiple antenna assemblies can be used, where each antenna assembly has plural antenna elements. A lower one of the antenna assemblies can be used to form high and lower power beams, and an upper one of the antenna assemblies can be used to communicate backhaul information, for example.

### TECHNICAL FIELD

The invention relates generally to forming spatial beams within a cell segment.

### BACKGROUND

Wireless communications networks are typically divided into cells, with each of the cells further divided into cell sectors. A base station is provided in each cell to enable wireless communications with mobile stations located within the cell.

To further sectorize a cell sector, beamforming schemes have been implemented, such as in orthogonal frequency domain multiple access (OFDMA) systems. A beamforming scheme refers to formation of multiple spatial beams within a cell sector to divide the cell sector into different coverage areas. Mobile stations can communicate with the base station using one or more of these spatial beams.

One type of beamforming scheme is an adaptive beamforming scheme that dynamically directs beams toward a location of a mobile station. Such an adaptive beamforming scheme requires mobility tracking, in which locations of mobile stations are tracked for the purpose of producing the adaptive beams. However, mobility tracking is associated with relatively large overhead and complications. Moreover, mobility tracking may not be possible or practical with mobile stations that are moving at relatively high velocities.

### SUMMARY

In general, according to a preferred embodiment, a method of wireless communications in a wireless network comprises forming at least two spatial beams within a cell segment, where the at least two spatial beams are associated with different power levels. The at least two spatial beams can be moved across the cell segment according to a sweep pattern. Some other spatial beams can have the same power level.

Other or alternative features will become apparent from the following description, from the drawings, and from the claims.

### BRIEF DESCRIPTION OF THE DRAWINGS

FIG. 1 illustrates an exemplary cell that is associated with a base station that is capable of forming spatial beams having different power levels that are moved according to a sweep pattern, in accordance with a preferred embodiment.

FIG. 2 illustrates spatial beams associated with different beam positions that are formed within a cell sector, in accordance with a preferred embodiment.

FIGS. 3A-3F illustrate sweep patterns of the spatial beams, in accordance with an embodiment.

FIGS. 4-5 illustrate different beam configurations, in accordance with some preferred embodiments.

FIG. 6 illustrates spatial beams formed in different cell sectors, in accordance with a preferred embodiment.

FIG. 7 is a front view of an antenna structure of a base station that has two antenna panels, where each antenna panel has antenna elements capable of forming spatial beams according to some preferred embodiments.

FIG. 8 is a side view of the antenna structure of FIG. 7.

FIG. 9 illustrates a first configuration of spatial beams generated in two different cells, in accordance with an embodiment.

FIG. 10 illustrates a second configuration of spatial beams generated in two cells, according to another embodiment.

FIGS. 11 and 12 illustrate different techniques of communicating control and data signaling, in accordance with some preferred embodiments.

FIGS. 13 and 14 illustrate frame structures for communicating data, according to some preferred embodiments.

FIG. 15 is a block diagram of exemplary components of a base station and mobile station.

### DETAILED DESCRIPTION OF PREFERRED EMBODIMENTS

In the following description, numerous details are set forth to provide an understanding of some embodiments. However, it will be understood by those skilled in the art that some embodiments may be practiced without these details and that numerous variations or modifications from the described embodiments may be possible.

In accordance with some preferred embodiments, an “opportunistic” space time multiple access (OSTMA) technique is provided for use in wireless communications networks. The OSTMA technique enables the formation of multiple spatial beams in a cell segment (cell or cell sector), where at least some of the multiple spatial beams of the cell segment are associated with different power levels to provide different coverage areas within the cell segment. In addition, the OSTMA technique defines a sweep pattern for the beams within a cell segment, where the sweep pattern can be a fixed sweep pattern or a dynamic sweep pattern. A “spatial beam” (or more simply “beam”) refers to a geographically distinct coverage region within a cell segment in which wireless communication between a base station and mobile station(s) can be performed.

A “sweep pattern” refers to a manner in which beams within a cell segment are moved, over time, among beam positions in the cell segment. A fixed sweep pattern means that the beams are moved among the beam positions according to a predetermined sequence. A dynamic sweep pattern means that the beams can be moved among the beam positions in possibly different sequences, depending upon one or more criteria. According to preferred embodiments, the beam positions across which beams are moveable are fixed beam positions—thus, although the spatial beams are moveable within the cell segment, the positions to which such beams are moved remain fixed.

In some preferred embodiments, the OSTMA scheme is provided for the forward wireless link (from the base station to the mobile stations). In alternative embodiments, the OSTMA scheme can also be used for the reverse wireless link (from the mobile station to the base station).

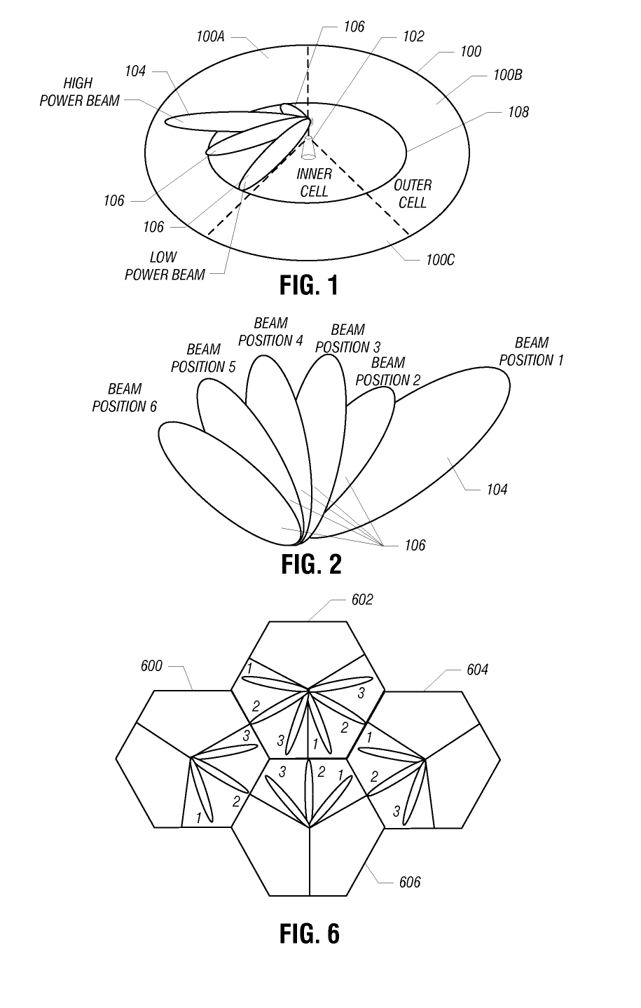

In one example, as depicted in FIG. 1, a cell 100 has three sectors 100A, 100B, and 100C. Within sector 100A, a base station 102 has an antenna structure that forms multiple spatial beams, including a high-power beam 104 and low-power beams 106. A “high-power beam” refers to a beam in which wireless communications is performed at an elevated transmission power, whereas a “low-power beam” refers to a beam in which wireless communications is performed at a transmission power less than the elevated transmission power.

Note that the high-power beam 104 is able to provide a coverage area from the antenna structure 102 to an edge of the cell 100. On the other hand, the low-power beams 106 are able to provide coverage up to an inner edge 108, where the inner edge has a radius that is smaller than a radius associated with the outer edge of the cell 100. In FIG. 1, the coverage area within the inner edge 108 is referred to as an “inner cell region,” and the ring-shaped area between the inner cell region and the outer edge of the cell 100 is referred to as an “outer cell region.” The high-power beam 104 provides coverage for mobile stations located in both the inner and outer cell regions, whereas the low-power beams 106 are used to provide coverage for mobile stations located within the inner cell region (but not the outer cell region). The low power beams can be operable at substantially similar power levels, or dissimilar power levels, in each instance at a transmission power that is less than the high power level. Although just one high-power beam 104 is depicted, it is noted that multiple high-power beams 104 can be used in alternative preferred embodiments.

Employing low-power beams 106 allows for less interference within each of the cell sectors 100A, 100B, and 100C. This is contrasted with conventional techniques in which multiple beams formed within a cell sector have a fixed power level, where the fixed power level is high enough such that the beam can cover all the way to the edge of the cell sector. As a result, by employing multiple beams all at the same relatively high power level, interference is increased within the cell sector. In contrast, using the OSTMA technique according to some preferred embodiments in which some of the beams of a cell sector are lower power than other beams in the cell sector, reduced interference is achieved.

Although reference is made to providing spatial beams in a cell sector in this description, it is noted that similar techniques can be provided for entire cells.

In accordance with some preferred embodiments, since not all of the spatial beams within a cell sector are able to provide coverage to mobile stations within the outer cell region, the high-power beam 104 can be moved to different beam positions to provide coverage for different mobile stations located at different locations in the outer cell region.

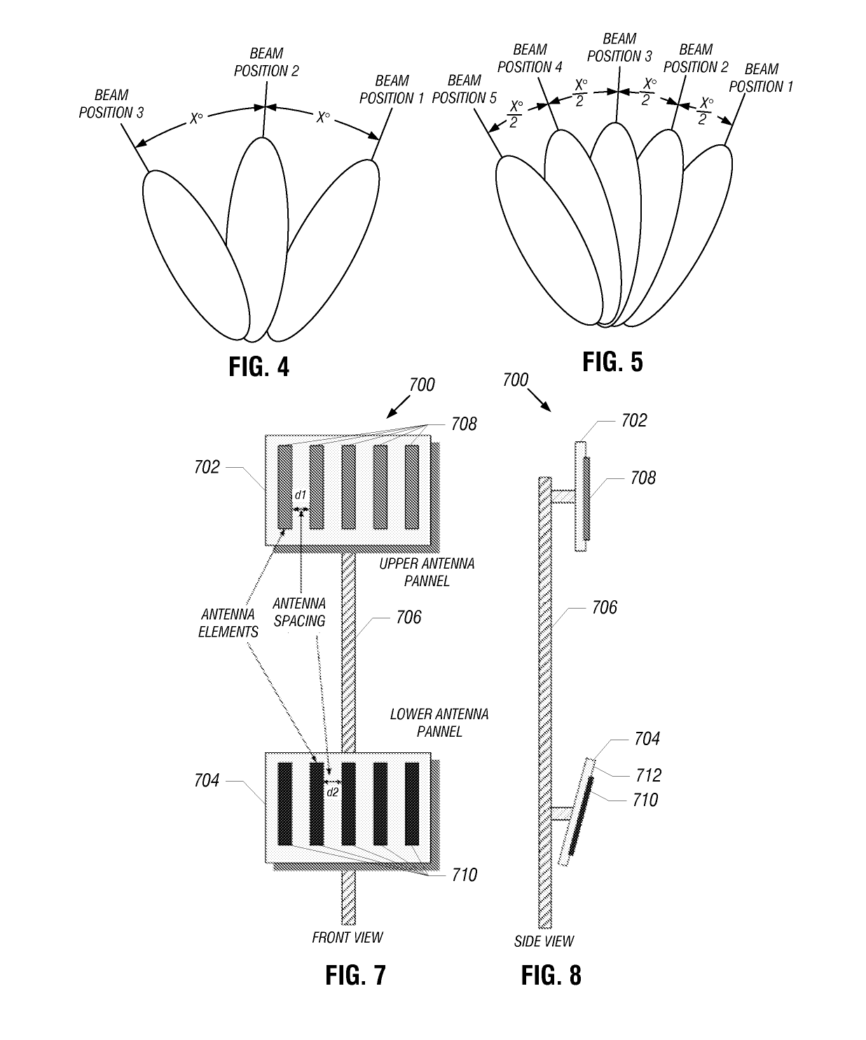

The beams within a cell sector or cell can be non-overlapped beams (such as depicted in FIG. 4), or overlapped beams (such as depicted in FIG. 5). In some implementations, beams are considered non-overlapped if the following is true: if the 3-dB (decibel) beamwidth is x^{o}, then the beams are separated by about every x^{o}, as depicted in FIG. 4.

Beams are considered to be overlapped if the following condition is true: if the 3-dB beamwidth is x^{o}, the beams are less than some predefined fraction (e.g., ½) of x^{o}. FIG. 5 shows an example in which adjacent beams are separated by x/2^{o} separation.

FIG. 2 shows an example in which six possible beam positions are provided. In the example of FIG. 2, the high-power beam 104 is provided in beam position 1, whereas the low-power beams 106 are provided in beam positions 2-6. Beam positions 1-6 are the fixed beam positions across which the low and high-power beams 104, 106 can be swept.

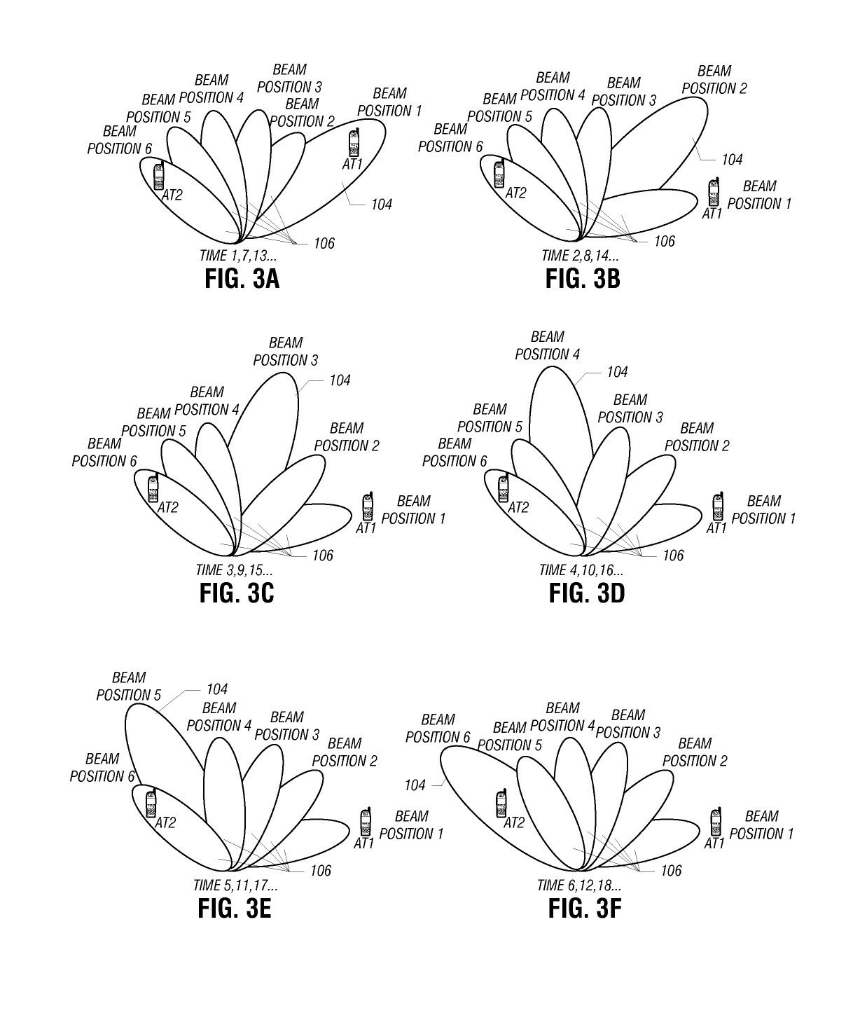

Sweeping of the beams among the six exemplary beam positions of FIG. 2 is depicted in FIGS. 3A-3F. FIGS. 3A-3F also depict two mobile stations (labeled AT1 and AT2). Mobile station AT1 is located in the outer cell region and thus within the reach of the high-power beam 104, but not the low-power beams 106. On the other hand, mobile station AT2 is located within the inner cell region and thus is within the coverage area of the low-power beams 106. At time interval 1 (FIG. 3A), the high-power beam in the example depicted in FIGS. 3A-3F is located in beam position 1. The low-power beams 106 are located in beam positions 2-6.

At time interval 2 (FIG. 3B), the high-power beam 104 has moved to beam position 2, and a low-power beam 106 is now in beam position 1. Note that in FIG. 3B, mobile station AT1 is outside the coverage region of the low-power beam 106 in beam position 1. At time interval 3, the high-power beam 104 has moved to beam position 3, with a low-position beam replacing the high-power beam in beam position 2.

The movement of the high-power beam 104 and low-power beams 106 continues in each of the successive time intervals 4, 5, and 6 (FIGS. 3D, 3E, and 3F, respectively). The six time intervals together make up a sweep period. Within a sweep period, the high-power beam 104 is moveable to cover all possible beam positions. More generally, within each sweep period, any given beam is moveable to cover all possible beam positions.

The sweep pattern then repeats for the next beam period, with the high-power beam 104 returning to beam position 1 at time interval 7 and continuing on to time interval 12.

The sweep pattern depicted in FIGS. 3A-3F is an example of a fixed (or deterministic) pattern in which each beam rotates by one beam position with each time interval. In a different embodiment, other patterns can be used, including other types of deterministic patterns or even random patterns.

In alternative embodiments, instead of using a fixed sweep pattern, a dynamic sweep pattern can be employed. With the dynamic sweep pattern, the movement of beams across the beam positions of a cell sector can be dynamically based on one or more of the following criteria: presence of mobile stations within a geographic region of a cell sector, channel conditions (e.g., conditions of wireless links), quality of service (QoS) requirements of applications involved in wireless communications, loading of channels, and so forth.

For example, depending upon the one or more criteria, instead of having the high-power beam 104 sweep in the deterministic manner depicted in FIGS. 3A-3F, a scheduler associated with a base station can specify that the high-power beam remain in a particular beam position for more than one time interval. Also, the scheduler can specify that rather than the high-power beam 104 progressively moving to the next beam position with each time interval, the high-power beam can instead be moved to another target beam position several positions away. Instances where it may be desirable to move the high-power beam in this manner include instances where the scheduler may have detected that mobile stations at the target beam position may require servicing (e.g., such mobile stations may have higher QoS requirements that would indicate that priority should be given to servicing such mobile stations over other mobile stations with lower QoS requirements).

The sweep pattern of beams provides for spatial variation of the beams. In addition to providing spatial variation, some preferred embodiments also allows for time-based variation, which is defined by beam duration (the amount of time a beam remains at a particular beam position). Generally, the beam design according to preferred embodiments is specified by a sweep pattern and beam duration of a beam. The sweep pattern (fixed or dynamic) is specified by a sequence of beam positions as time evolves. The beam duration can also be fixed or dynamic.

In some embodiments, note that each beam can have its own sweep pattern and beam duration. The base station can coordinate the multiple sweep patterns and beam durations of the multiple beams within a cell or cell sector.

Also, different cells or cell sectors can use different sets of fixed beam positions, as well as different numbers of beams that are turned on simultaneously. The sweep patterns and/or beam durations can also differ in different cells or cell sectors. Coordination between multiple base stations would be desirable to reduce inter-cell/inter-sector interference and to support network-based MIMO (multiple input multiple output) (which refers to the ability of a transmitter that has multiple antennas to send multiple information simultaneously for receipt by multiple antennas of a receiver).

In some embodiments, four possible configurations may be available: (1) configuration 1 (static sweep pattern and static beam duration); (2) configuration 2 (dynamic sweep pattern and dynamic beam duration); (3) configuration 3 (dynamic sweep pattern and static beam duration); and (4) configuration 4 (static sweep pattern and dynamic beam duration).

With configuration 1, where a static (fixed) sweep pattern with static (fixed) beam duration are used, one possible benefit is that less control overhead and feedback would be required. For example, with a fixed sweep pattern and fixed beam duration, the time interval within a sweep period can be implicitly used as a beam identifier and the mobile station does not have to provide any feedback regarding the beam identifier. The mobile station can also run predictive algorithms, such as to listen to the forward link only when the mobile station expects the beam to sweep to its location. Discontinuous transmission (DTX) can be performed if there is no mobile station within a particular coverage area of a beam. DTX refers to gating applied to a transmitter to turn off a transmission.

The sequence of beam positions that describe the sweep pattern can be sequential, pseudorandom, or coded in terms of beam positions. In the example where there are five beams per cell sector, one example of a sequential sweep pattern is as follows: {1, 2, 3, 4, 5, 1, 2, 3, 4, 5, . . . }. What this means is that a particular beam goes to beam position 1 in a first time interval, position 2 in a second time interval, position 3 in a third time interval, position 4 in a fourth time interval, position 5 in a fifth time interval, back to position 1 again in the sixth time interval, and so forth.

An example of a pseudorandom sweep pattern is as follows: {2, 5, 3, 1, 4, 2, 5, 3, 1, 4 . . . }. Note that the difference between the pseudorandom sweep pattern and the sequential sweep pattern is that within a sweep period of five time intervals, the sequence of the sweep does not progress from position 1 to position 2 to position 3 to position 4 to position 5, but rather the sweep of a particular beam is randomized. In the example above, a beam position starts in position 2 in a first time interval, proceeds to position 5 in a second time interval, proceeds to position 3 in a third time interval, proceeds to position 1 in a fourth time interval, and proceeds to position 4 in a fifth time interval. This sequence repeats again in the next sweep period. Thus, from sweep period to sweep period, the pseudorandom sweep pattern is the same.

A coded sweep pattern refers to a sweep pattern that depends upon which cell sector the beams are located in. Different cell sectors (associated with different codes) would use different sweep patterns. FIG. 6 shows an example that has multiple cells 600, 602, 604, and 606, with each cell having three cell sectors. In the example of FIG. 6, it is assumed that there are three beams per cell sector. The beam positions are numbered sequentially from 1 to 3 in a counter-clockwise direction. The sweep pattern of a cell sector in cell 606 can be: {1, 2, 3, 1, 2, 3, . . . }, the sweep pattern of a cell sector of each of cells 600 and 604 can be {2, 3, 1, 2, 3, 1, . . . }, and the sweep pattern in each cell sector of cell 602 can be {3, 1, 2, 3, 1, 2, . . . }. The different sweep patterns used in the different cells are designed to reduce inter-cell interference (interference between beams located in different cells).

In configuration 2, where dynamic sweep pattern and dynamic time duration are used, flexible on-demand beamforming can be provided. For example, a beam can be formed based on mobile station presence in a coverage area of a beam, based on the channel condition, based on QoS, and based on support of special transmission schemes, such as network-based MIMO. However, although flexibility is enhanced, complexity of the base station scheduler and feedback mechanism can be increased. To enable dynamic sweep pattern and dynamic beam duration, pre-flash messages (discussed further below) can be sent by the base station to allow mobiles stations to report measurements back to the base station.

The other configurations that can be employed include configuration 3, which uses dynamic sweep pattern and static beam duration, and configuration 4, which uses static sweep pattern and dynamic beam duration.

More generally, the dynamic variation of one or more characteristics (e.g., sweep pattern and/or beam duration) can be based on one or more of the following criteria: presence of mobile stations within a particular geographic region, channel conditions (e.g., conditions of wireless links), QoS requirements of applications involved in wireless communications, loading of channels, and so forth.

Another characteristic of beams that can be varied (based on one or more of the above-listed criteria) is beam duty cycle, which specifies the amount of time that a beam is on within the beam duration. The duty cycle of a beam refers to the ratio of the time that a beam is “on” versus the amount of time that a beam is “off” for a given beam position, during a given time interval. For example, the duty cycle of a particular beam in beam position 1 can be 70%. What that means is that the beam will be “on” for 70% of the time interval and “off” for 30% of the time interval. The ability to vary the duty cycle of a beam based on scheduling needs allows for lower interference levels, since beams that are no longer needed can be turned off temporarily.

In accordance with some preferred embodiment, base stations are able to perform “pre-flash” to enable dynamic adjustment of one or more characteristics (e.g., sweep pattern, beam duration, and beam duty cycle). For example, when a dynamic sweep pattern is used, a high-power beam may be located in a particular beam position for a relatively extended period of time. This may cause other mobile stations in the outer cell region not being able to communicate with the base station for the relatively extended period of time. To address such issue, pre-flashing can be used, where pre-flashing refers to a procedure in which a base station issues a short pilot burst (or burst of other messaging) to a particular direction. Mobile stations in the coverage area corresponding to the particular direction can then make measurements of the pre-flash message and provide reports back to the base station regarding the measurements. In one example, a mobile station can report an indication of wireless channel quality, such as in the form of a channel quality indication (CQI). The base station can perform pre-flashes in all directions of a particular cell sector. Using the measurement reports from the mobile stations, the base station is able to perform scheduling as discussed above by dynamically adjusting beam duration, duty cycle, and beam scheduling.

Note that the pre-flashes issued by the base station and actual traffic transmissions can be time multiplexed with different periodicities (which means that the periods during which pre-flashes are transmitted can be adjusted relative to the periods during which traffic is transmitted). For example, the pre-flashes can be issued in the middle of a lengthy download of data to a particular mobile station, with the pre-flashes done in a time multiplexed manner with the download of data to the particular mobile station.

In accordance with some embodiments, as depicted in FIG. 7, an antenna structure 700 (which is part of a base station, such as base station 102 in FIG. 1) can be provided with multiple antenna assemblies, including an upper antenna assembly 702 mounted to an antenna support 706, and a lower antenna assembly 704 mounted to the antenna support. In the implementation depicted in FIG. 7, each of the antenna assemblies 702 and 704 is an antenna panel. The antenna assembly 704 is positioned below (in the vertical direction) the upper antenna assembly 702.

The antenna assembly 702 includes multiple antenna elements 708. The lower antenna assembly 704 includes multiple antenna elements 710. The antenna elements 708 and 710 can cooperate to form the beams within a cell sector that is served by the antenna structure 700.

A side view of the antenna structure 700 is depicted in FIG. 8. Note that the lower antenna panel 704 is angled with respect to the vertical axis of the support 706, such that the forward face 712 (on which the antenna elements 710 are mounted) face slightly downwardly (at an angle). In the example of FIG. 8, the upper antenna panel 702 is generally parallel to the vertical axis of the support 706. In other implementations, other arrangement of the upper and lower antenna panels 702 and 704 can be provided. In yet another implementation, more than two antenna panels can be used.

In one exemplary implementation, the antenna elements 708 of the upper antenna panel 702 can be used for forming beams to cover the outer cell region as well as to communicate with adjacent base stations in the neighboring cells. The lower antenna panel 704 can be used to form low-power beams for a given cell sector, as well as possibly a high-power beam to cover up to the edge of a particular cell sector.

The information that is communicated in beams between base stations in different cells includes backhaul information and coordination information. The coordination information can be used to coordinate handover of mobile stations between different cells. The coordination information can also enable coordination of sweep patterns and sweep durations in different cells to reduce inter-cell/inter-sector interference, and to support network-based MIMO.

“Backhaul” information refers to control and data typically communicated over a backhaul connection between a base station and a wireless network controller (e.g., packet data serving node, serving gateway, etc.). An issue associated with wireless communications networks is that the sizes of cells can be relatively small, particularly in densely populated areas such as urban areas. Another reason for small cell sizes can be requirements for high data rates or high carrier frequencies. With smaller cell sizes, a larger number of cells (and thus corresponding base stations) are present. Each base station typically has to be connected by a backhaul network to a wireless network controller. A large number of base stations means that a corresponding large number of backhaul connections would have to be provided. Backhaul connections can be expensive to deploy, and providing a relatively large number of such backhaul connections in a wireless communications network can increase the costs for a wireless network operator.

In accordance with some preferred embodiments, to reduce the number of backhaul connections that would have to be deployed, the antenna structures of base stations can form beams (referred to as “backhaul beams”) used to carry backhaul information. For example, in FIGS. 7-8, a beam of the upper antenna panel 702 can be employed for the purpose of communicating the backhaul information to another base station that may be connected by a backhaul connection to the wireless network controller. In general, a subset of base stations in a wireless network can be deployed with backhaul connections to a wireless network controller. The remaining base stations are not deployed with backhaul connections—rather, such base stations communicate backhaul information over beams to corresponding base station(s) deployed with a backhaul connection.

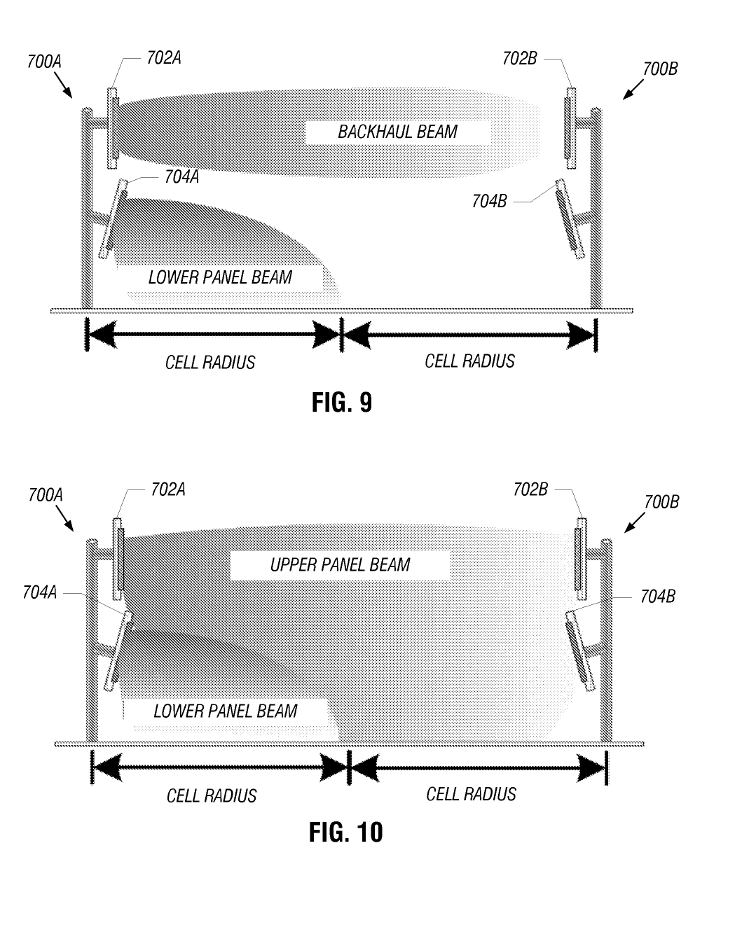

FIG. 9 shows two antenna structures 700A and 700B located in two different corresponding cells. In the configuration of FIG. 9, there is no overlap of coverage zones between the upper and lower antenna panels 702A, 704A (and 702B and 704B). A backhaul beam can be formed between upper antenna panels 702A and 702B of the two antenna structures 700A and 700B, respectively. Each of the lower antenna panels 704A and 704B are used to form beams for coverage within respective cells.

FIG. 10 shows a configuration in which there is overlap of coverage by an upper panel beam and lower panel beam. In this manner, the two panels can provide MIMO in the outer cell region, where the multiple output antennas include some combination of antennas from the upper and lower panels. The multiple output antennas of the upper panel and lower panel together can thus provide for increased diversity gain, multiplexing gain, and/or array gain.

Various other configurations are also possible. For example, at different times, the upper and lower antenna panels can be used to provide different coverages. For example, in one time period, the lower panel can be used to cover the entire cell. In another time period, the upper panel can be used to cover just the outer cell region, as well as to provide a backhaul beam. In yet another time period, both the lower and upper panels can be used to cover the outer cell region.

In yet another configuration, in a first time period, the lower panel can be used to cover the inner cell region, while the upper antenna panel is used to provide the backhaul beam. In a different time period, both the lower and upper antenna panels are used to cover the outer cell region.

Depending on the desired configuration, the upper and lower antenna panels can be placed close together or far apart. Also, the two antenna panels can use antenna elements having different antenna polarizations. The two antenna panels can operate independently or cooperatively. The two antenna panels can be transmitting in a time division multiplex manner or simultaneously. Alternatively, the two antenna panels can be transmitted in a frequency domain multiplex (FDM) manner or at the same frequency.

Moreover, if there is coordination between the upper and lower antenna panels, a handoff of a mobile station is possible from a lower panel beam to an upper panel beam, or vice versa.

Note also that with use of upper and lower antenna panels, power levels of all beams for cell coverage formed by the antenna elements of the upper and lower panels can be at the same power level. In such configuration, the coverage of the inner cell region versus outer cell region (ring-based coverage) can be accomplished by orienting the upper and lower panels differently (e.g., the lower panel can be angled downwardly to cover the inner cell region, while the upper panel is not angled to cover the outer cell region.

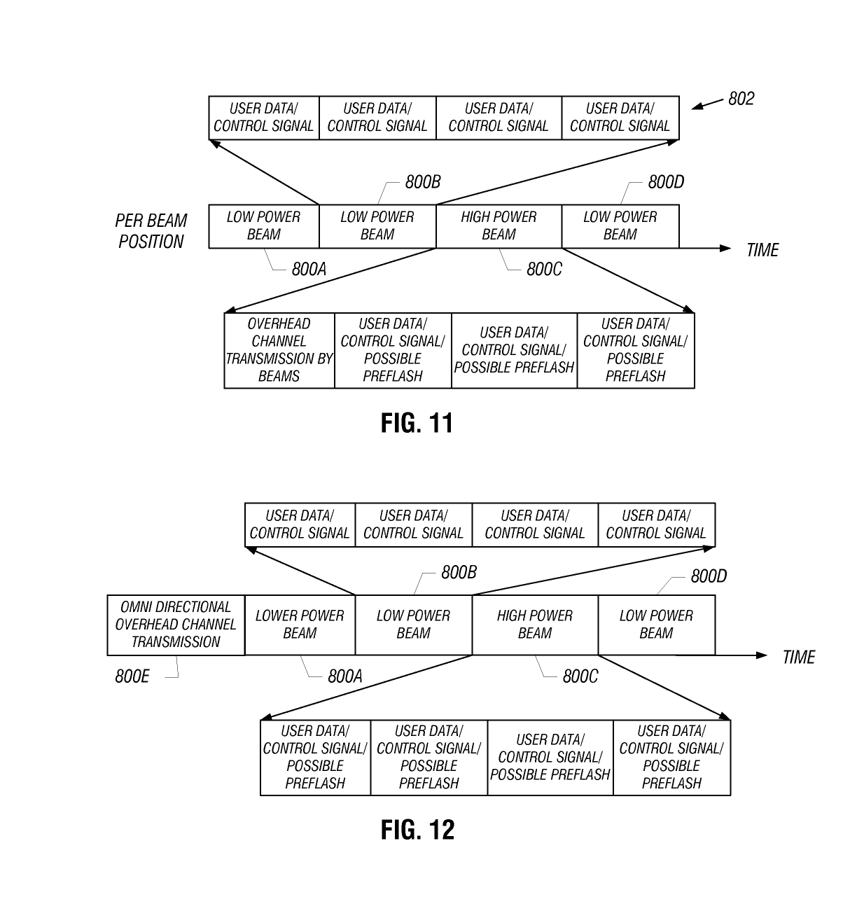

FIG. 11 shows, for a particular beam position within a cell sector, multiple time intervals 800A, 800B, 800C, and 800D. Low-power beams are transmitted in time intervals 800A, 800B, and 800D, and a high-power beam is transmitted in time interval 800C. As depicted in FIG. 11, a low-power beam, such as the low-power beam in time interval 800B, can be used to transmit user data and control signals, as represented by 802. On the other hand, the high-power beam in time interval 800C can be used to transmit user data and control signals, as well as other control information, such as broadcast overhead channels and pre-flash messages. Broadcast overhead channels can include a system acquisition channel containing time and frequency synchronization information, as well as cell, sector, or beam identifier information; and a system broadcast overhead channel, that can carry system parameters such as beam sweep patterns, and so forth.

In an alternative implementation, in addition to low-power beams and a high-power beam transmitted in time intervals 800A, 800B, 800C, and 800D, another time interval 800E (FIG. 12) can be allocated to transmit an omni-directional overhead channel. An omni-directional transmission means that the overhead channel is broadcast in all directions of a particular cell sector (or cell). If omni-directional transmission is used, there can be time, space, or frequency coordination among transmissions of the omni-directional overhead channels by different base stations to enhance better signal reception at the mobile station (and to reduce interference between different cells).

In some implementations, OSTMA may be applied to the forward link, but not to the reverse link. In such implementation, if the cell size is designed based on the reach of the forward link, then the forward link may have a further reach (due to presence of the high-power beam) than a mobile station would have in the reverse link. To address this issue, a relaying feature (referred to as “ad hoc relay”) can be provided in mobile stations within a cell sector, where one mobile station is able to listen to another mobile station and to relay the information of the other mobile station to the base station. For example, a first mobile station can be located near the edge of a particular cell sector, while a second mobile station is located closer to the base station. In this scenario, information transmitted in the reverse link by the first mobile station can be relayed by the second mobile station to the base station. Without the relay, the transmission from the first mobile station may not be able to reliably reach the base station.

To transmit reverse link information from the first mobile station to the second mobile station for ad hoc relay as discussed above, in a time division duplexing (TDD) system, an unused forward link time slot can be reused for relaying reverse information from the first mobile station to the second mobile station in the reverse link direction.

Also, for more robust communication of control channels when the cell size is designed based on the forward link reach, the mobile station can transmit traffic data to just one base station, but can transmit control channels to multiple base stations using ad hoc relay to ensure that control channels reach the intended serving base station.

Another issue associated with designing cell sizes based on forward link reach is that reverse link control message ACK may be slow in getting back to the base station due to the ad hoc relay as discussed above. To address this, the base station can simply transmit bursts of traffic data without waiting for responsive acknowledgments.

Alternatively, the cell size can be designed based on the reach of the reverse link, in which case cell sizes would be smaller. In such an implementation, a base station can reach multiple cells in the forward link; as a result, it may be possible that the serving cell sector for the forward link is different from the serving cell sector for the reverse link. For example, base station A in cell A can be the forward link serving base station, whereas base station B in cell B is the reverse link serving base station. Base station A can reach both cell A and cell B, but a mobile station in cell B can only reach base station B. In this scenario, certain reverse control messages, such as CQI messages or reverse acknowledgment (R-ACK) messages, can be sent on the reverse link from the mobile station to base station B, which then relays the control messages to base station A (which is the forward link serving base station).

It is noted that certain types of control information may have to be delivered to all mobile stations in all directions. However, since the high-power beam covers just one beam position in any give time interval, the high-power beam cannot be used to transmit such control information to all mobile stations. To address this, such control information can be transmitted by the base station in low-power beams with low code rates (which enables a higher probability decoding of such control information by mobile stations located near the cell edge). Examples of control information that may have to be delivered to all mobile stations in all directions include a forward line acknowledgment channel (to provide acknowledgments to mobile stations) and forward link power control channel (to provide power control messages to mobile stations).

If a dynamic sweep pattern and/or dynamic beam duration is used, which may mean that beam identifiers would have to be provided to mobile stations, the base station can also use low-power beams with low code rates to deliver the beam identifiers to mobile stations located near the cell edge. The beam identifier allows a mobile station to know which next beam will be turned on.

It is noted that in some embodiments, an OSTMA subsystem can be integrated with a non-OSTMA system. A non-OSTMA system does not employ the OSTMA techniques discussed above.

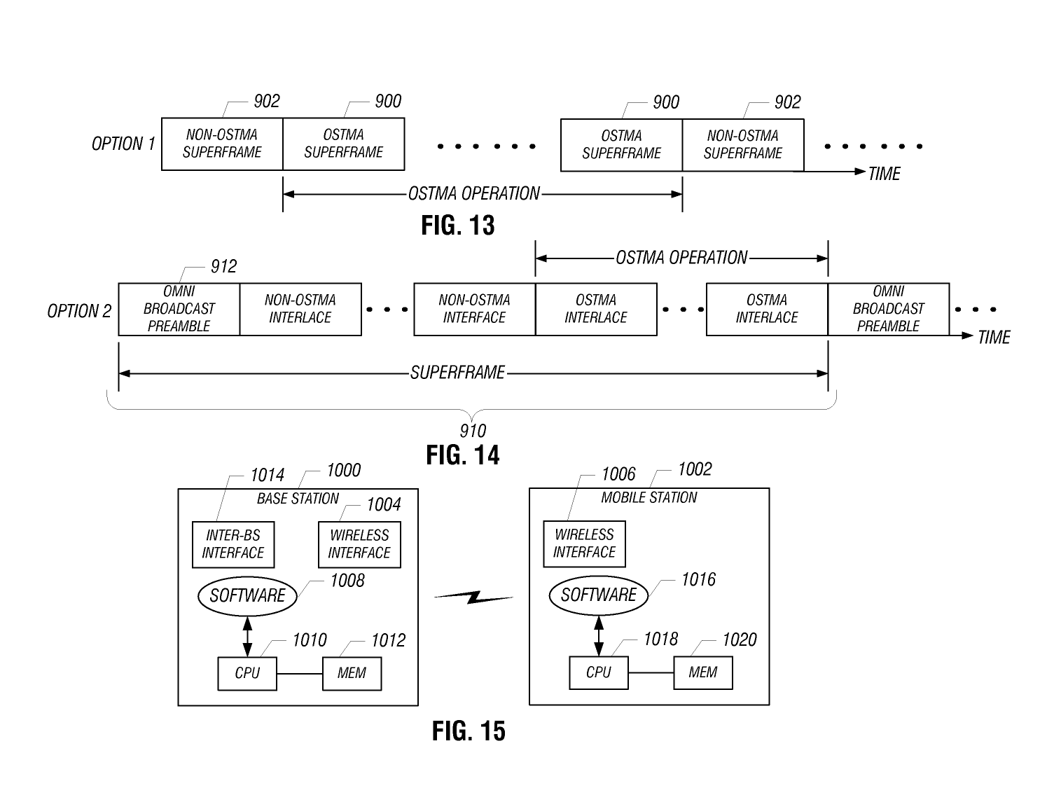

In this scenario, interleaving of OSTMA data and non-OSTMA data can be performed over a wireless link. For example, as depicted in FIG. 13, OSTMA superframes 900 are transmitted during an interval associated with OSTMA operation, whereas non-OSTMA superframes 902 are transmitted outside the time periods of OSTMA operation. A “superframe” refers to a frame structure that contains other frames. More generally, reference is made to a “frame,” which is a collection of data that is sent over a wireless link.

In an alternative embodiment, as depicted in FIG. 14, a superframe 910 can include non-OSTMA data interlaced with OSTMA data. The beginning of the superframe 910 can include an omni-broadcast preamble 912 to indicate positions of non-OSTMA data and OSTMA data.

In alternative implementations, other frame structures can be used.

Exemplary components of a base station 1000 and mobile station 1002 are depicted in FIG. 15. The base station 1000 includes a wireless interface 1004 to communicate wirelessly over a wireless link with a wireless interface 1006 in the mobile station 1002. The base station 1000 includes software 1008 that is executable on one or more central processing units (CPUs) 1010 in the base station 1000 to perform tasks of the base station. The CPU(s) 1010 is (are) connected to a memory 1012. The software 1008 can include a scheduler and other software modules. The base station 1000 also includes an inter-base station interface 1014 to communicate information with another base station, such as backhaul information and/or coordination information.

Similarly, the mobile station 1002 includes software 1016 executable on one or more CPUs 1018 connected to a memory 1020. The software 1016 is executable to perform tasks of the mobile station 1002.

Instructions of such software (1008 and 1016) can be loaded for execution onto the CPUs or other types of processors. The processor can include a microprocessor, microcontroller, processor module or subsystem (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of wireless communications in a wireless network, comprising:
forming at least two spatial beams within a cell segment, wherein the at least two spatial beams are associated with different power levels; and
sweeping the at least two spatial beams across the cell segment according to a sweep pattern.

2. The method of claim 1, wherein sweeping the at least two spatial beams is controlled by a scheduler that schedules communications in the cell segment.

3. The method of claim 1, wherein a first of the at least two spatial beams provides coverage in a first coverage area in the cell segment, and
a second of the at least two spatial beams provides coverage in a second coverage area in the cell segment, wherein the second coverage area is larger than the first coverage area.

4. The method of claim 1, further comprising forming another spatial beam to communicate information between base stations.

5. The method of claim 4, wherein communicating the information between base stations comprises communicating backhaul information between the base stations.

6. The method of claim 4, wherein communicating the information between base stations comprises communicating information between the base stations to enable coordination of either mobile station handover or multiple input multiple output (MIMO) service.

7. The method of claim 4, wherein forming the another spatial beam comprises forming the another spatial beam using a first antenna assembly, and
wherein forming the at least two spatial beams comprises forming the at least two spatial beams using a second antenna assembly located lower than the first antenna assembly.

8. The method of claim 4, wherein forming the another spatial beam comprises forming the another spatial beam using a first antenna assembly,
wherein one of the at least two spatial beams is formed using the first antenna assembly, and
wherein another of the at least two spatial beams is formed using a second antenna assembly located lower than the first antenna assembly.

9. The method of claim 1, wherein the sweep pattern is a fixed sweep pattern having a number of beam positions across which the at least two spatial beams are swept in different time intervals.

10. The method of claim 1, wherein the sweep pattern is a dynamic sweep pattern in which movement of the at least two spatial beams across a number of beam positions is according to one or more criteria.

11. The method of claim 1, further comprising dynamically adjusting beam durations in different beam positions of the sweep pattern.

12. A wireless node, comprising:
a wireless interface to communicate wireless information with a corresponding node; and
a processor to:
transmit the wireless information in multiple beams, wherein at least one of the multiple beams has a higher power level than another of the multiple beams, and
wherein the multiple beams are moveable across beam positions in a cell segment over time according to a sweep pattern.

13. The wireless node of claim 12, comprising one of a base station and a mobile station.

14. The wireless node of claim 12, wherein the sweep pattern defines fixed beam positions across which the multiple beams are swept according to the sweep pattern.

15. The wireless node of claim 12, wherein the sweep pattern is a dynamic sweep pattern that adjusts positions of the multiple beams according to one or more of the following criteria: presence of mobile stations in a geographic region of the cell segment, wireless channel condition, quality of service (QoS) requirements, and loading of channels.

16. The wireless node of claim 12, comprising a base station, wherein the base station includes an inter-base station interface to enable communication of backhaul information over one of the multiple beams to another base station.

17. The wireless node of claim 12, wherein the processor is configured to further:
transmit pre-flash messages to mobile stations to enable the mobile stations to make measurements and to provide reports based on the measurements back to the wireless node; and
dynamically adjust the sweep pattern in response to the reports.

18. An article comprising at least one computer-readable storage medium containing instructions that when executed cause a processor in a base station to:
transmit information in plural spatial beams within a cell segment to provide service to mobile stations within the cell segment, wherein the spatial beams are swept in the cell segment according to a sweep pattern and wherein at least one of the spatial beams has a higher power level than another of the spatial beams; and
transmit backhaul information in another spatial beam between the base station and another base station.

19. The article of claim 18, wherein the instructions when executed cause the processor to further:
communicate an overhead control channel in one of the spatial beams.

20. The article of claim 18, wherein the instructions when executed cause the processor to further:
coordinate with a second base station to employ the sweep pattern that is different from a sweep pattern used by the second base station.
